(19) United States
(12) Patent Application Publication
(10) Pub. No.: US 2020/0103714 A1
(43) Pub. Date: Apr. 2, 2020

(54) DISPLAY PANEL AND DISPLAY

(71) Applicants: HKC CORPORATION LIMITED, Shenzhen, Guangdong (CN); CHONGQING HKC OPTOELECTRONICS TECHNOLOGY CO., LTD., Chongqing (CN)

(72) Inventor: Shishuai Huang, Chongqing (CN)

(21) Appl. No.: 16/312,781

(22) PCT Filed: Nov. 6, 2018
(86) PCT No.: PCT/CN2018/114218

§ 371 Date: Dec. 21, 2018

(30) Foreign Application Priority Data
Sep. 30, 2018 (CN) 201821622227.X

(51) Int. Cl. G02F 1/1343; G02F 1/1339; G02F 1/1335

(52) U.S. Cl. CPC G02F 1/134309; G02F 1/13394; G02F 1/133514; G02F 1/133512; G02F 2001/134318; G02F 2201/121; G02F 2001/13398

(57) ABSTRACT

A display panel (100) including a color film structure layer (10) and an array structure layer (20). The color film structure layer (10) includes: a first substrate (11), a first conductive layer (13), and a color filter layer (14). The array structure layer (20) includes a second substrate (24) and a second conductive layer (22).

### CROSS-REFERENCE TO RELATED APPLICATIONS

This application is the International Application No. PCT/CN2018/114218 for entry into US national phase with an international filing date of Nov. 6, 2018, designating US, now pending, and claims priority to Chinese Patent Application No. 201821622227.X, filed on Sep. 30, 2018, the content of which is incorporated herein by reference in its entirety.

### BACKGROUND OF THE INVENTION

### Field of the Invention

The present application relates to the technical field of displaying, and more particularly to a display panel and a display.

### Description of Related Art

A current liquid crystal display (LCD) includes: a color filter (CF) layer, an array structure layer, and a liquid crystal layer sandwiched between the CF layer and the array structure layer. The CF layer is also called the color film structure layer. The liquid crystal layer is formed by injecting a liquid crystal between the CF layer and the array structure layer by one drop filing (ODF) technology, and then sealed by a seal to complete the assembling.

The CF layer has a conductive layer, which requires to be applied with a voltage before the displaying. The applied voltage is transmitted from a common electrode wire of the array structure layer to a conductive gold ball, and then transmitted from the conductive gold ball to the conductive layer.

However, the arrangement of the conductive gold ball would result in a long working procedure and therefore lower the production efficiency of the liquid crystal display.

### BRIEF SUMMARY OF THE INVENTION

It is an object of the present application to provide a display panel, which aims at solving the problem comprising, but not limited to long working procedure and low production efficiency when adopting conductive gold ball to transmit the voltage.

It is another object of the present application to provide a display, and the display comprises the above-mentioned display panel.

In one embodiment, the common electrode wire is provided with a productive layer; the productive layer defines therein with a conductive hole to expose the common electrode wire; the second conductive layer passes through the conductive hole and is in electrical connection with the common electrode wire and the first conductive layer.

In one embodiment, a surface of the productive layer is provided with a plurality of conductive strips; the respective conductive strip is in electrical connection with the second conductive layer and extends in a radial direction of the conductive hole, with all the conductive strips in a radial arrangement.

In one embodiment, the number of the conductive strips is four, and the four conductive strips are uniformly arranged and spaced from one another with the same angle.

In one embodiment, the first color resist comprises a red color resist, a blue color resist, and a green color resist.

In one embodiment, the respective second color resist is a monochrome color resist comprising a red color resist, a blue color resist, or a green color resist.

In one embodiment, the respective second color resist is a complex color resist comprising any two of a read color resist, a blue color resist, and a green color resist.

In one embodiment, the respective second color resist is a complex color resist comprising a read color resist, a blue color resist, and a green color resist.

In one embodiment, the respective second color resist is a transparent color resist.

In one embodiment, the first substrate is a glass substrate, and a thickness of the first substrate ranges from 0.52 to 0.58 mm.

In one embodiment, the second substrate is a glass substrate, and a thickness of the second substrate ranges from 0.52 to 0.58 mm.

In one embodiment, a plurality of common electrode wires are spaced from one another; and the array structure layer further comprises a conductive bar in connection with two adjacent common electrode wires.

In one embodiment, the display panel further comprises a liquid crystal layer; and the liquid crystal layer is arranged between the color film structure layer and the array structure layer.

In one embodiment, the display panel further comprises an annular seal configured to seal the color film structure layer and the array structure layer.

The second color resist provided by embodiments of the present application is arranged between the first color resist and the first conductive layer. One end of the second color resist supports the first color resist, and the other end of the second color resist is in abut connection with the first conductive layer. Moreover, a portion of the first conductive layer arranged between the second color resist and the second conductive layer is in electrical connection with the second conductive layer, which causes the first conductive layer to be directly in electrical connection with the second conductive layer, and it is not necessary to provide an additional conductive gold ball, thus saving the time of the working procedure and improving the production efficiency.

### BRIEF DESCRIPTION OF THE DRAWINGS

In order to more clearly illustrate the technical solution in embodiments of the present application, the following drawings, which are to be used in the description of the embodiments or the existing techniques, will be briefly described. It will be apparent that the drawings described in the following description are merely embodiments of the present application. Other drawings may be obtained by those skilled in the art without paying creative labor.

FIG. 1 is a structural schematic view of a display panel provided by one embodiment of the present application;

FIG. 2 is a structural schematic view of a common electrode wire of FIG. 1;

FIG. 3 is an enlarged view of part A of FIG. 2;

FIG. 4 is a structural schematic view of two adjacent common electrode wires;

FIG. 5 is a structural schematic view of two adjacent common electrode wires in another form;

FIG. 6 is a structural schematic view of a red color resist of the first color resist and a red boss;

FIG. 7 is a structural schematic view of a green color resist of the first color resist and a green boss;

FIG. 8 is a structural schematic view of a blue color resist of the first color resist and a blue boss; and

FIG. 9 is a structural schematic view of a display provided by one embodiment of the present application.

### DETAILED DESCRIPTION OF THE EMBODIMENTS

In order to make the technical problems to be solved, technical solutions, and beneficial effects of the present application more clear, the present application will be further described in detail hereinbelow with reference to the accompanying drawings and embodiments. It should be understood that the specific embodiments described herein are merely intended to explain the application rather than to limit the present application.

It should be noted that when an element is referred to as being “fixed” or “arranged” at/in/on another element, it can be directly at/in/on the other element. When an element is referred to as being “connected” to/with the another element, it can be directly or indirectly connected to/with the other element. It should be understood that terms “top”, “bottom”, “left”, “right”, and the like indicating orientation or positional relationship are based on the orientation or the positional relationship shown in the drawings, and are merely for facilitating the description of the present application, rather than indicating or implying that a device or component must have a particular orientation, or be configured or operated in a particular orientation, and thus should not be construed as limiting the application; and the specific meaning of the above terms can be understood by those skilled in the art according to specific circumstances. Moreover, the terms “first” and “second” are adopted for descriptive purposes only and are not to be construed as indicating or implying a relative importance or implicitly indicating the number of technical features indicated. Thus, features defining “first” and “second” may include one or more of the features either explicitly or implicitly. In the description of the present application, the meaning of “a plurality of” or “multiple” is two or more unless otherwise particularly defined.

In order to explain the technical solutions described in the present application, the following detailed description will be made combining with the specific drawings and embodiments.

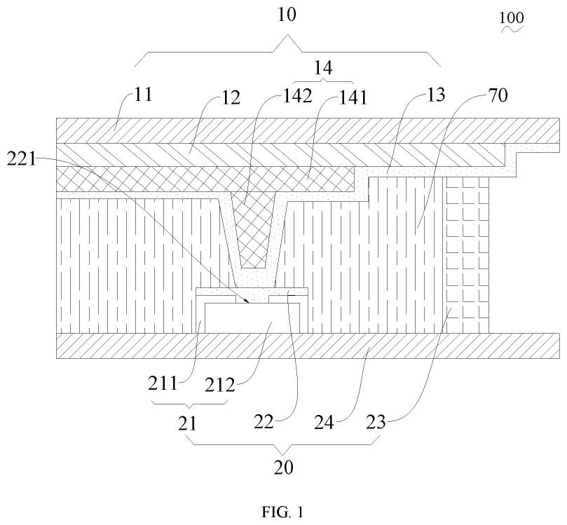

As shown in FIG. 1 and FIG. 9, embodiments of the present application provide a display panel 100 and a display 200. The display panel 100 comprises a color film structure layer 10, an array structure layer 20, and a liquid crystal layer 70 arranged between the array structure layer 20 and the color film structure layer 10.

The color film structure layer 10 is configured for displaying colors and comprises a first substrate 11 in a flat lying arrangement, a color filter layer 14 covering the first substrate 11, a black matrix layer 12 arranged between the color filter layer 14 and the first substrate 11, and a first conductive layer 13 covering the color filter layer 14. The color filter layer 14 is disposed between the first substrate 11 and the first conductive layer 13. The color filter layer 14 comprises a first color resist 141 covering the first substrate 11 and second color resists 142 overlying on the first color resist 141. A plurality of the second color resists 142 are provided and spaced from one another with an interval. The respective second color resists 142 is configured for supporting the color film structure layer 10 and the array structure layer 20, thereby keeping a distance between the color film structure layer 10 and the array structure layer 20 and enabling the color film structure layer 10 and the array structure layer 20 to have preset structural strength. In one embodiment, the first substrate 11 is a glass substrate featuring high temperature resistance, strong acid and alkali resistance, high light transmittance, and high flatness. Optionally, the first conductive layer 13 is made of indium tin oxide. Optionally, a thickness of the first substrate may range from 0.52 to 0.58 mm. The array structure layer 20 comprises: a second substrate 24 arranged opposite the first substrate 11, a common electrode wire 21 covering the second substrate 24 and configured for transmitting electrical signals, and a second conductive layer 22 in electrical connection with the common electrode wire 21. The liquid crystal layer 70 is arranged between the color film structure layer 10 and the array structure layer 20. Optionally, the second substrate 24 is also a glass substrate, and a thickness of the second substrate may range from 0.52 to 0.58 mm. The second conductive layer 22 is also made of indium tin oxide. The common electrode wire 21 is configured to transmit an electrical signal to the second conductive layer 22.

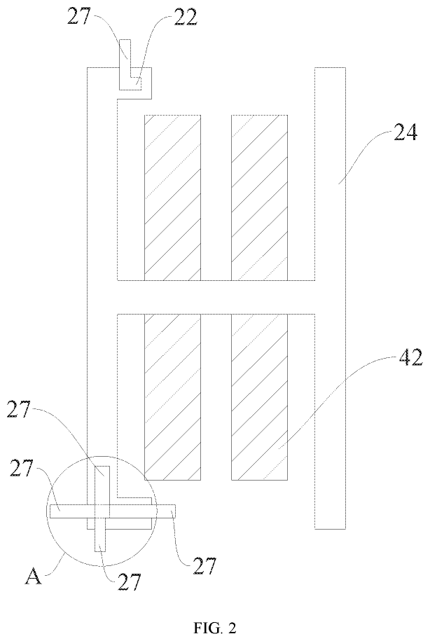

As shown in FIGS. 1 to 3, the second color resist 142 is arranged between the first color resist 141 and the first conductive layer 13. One end of the second color resist 142 supports the first color resist 141, and the other end of the second color resist 142 is in abut connection with the first conductive layer 13. A portion of the first conductive layer 13 arranged between the second color resist 142 and the second conductive layer 22 is in electrical connection with the second conductive layer 22, which causes the first conductive layer 13 to be directly in electrical connection with the second conductive layer 22, and it is not necessary to provide an additional conductive gold ball, thus saving the time of working procedure and improving the production efficiency.

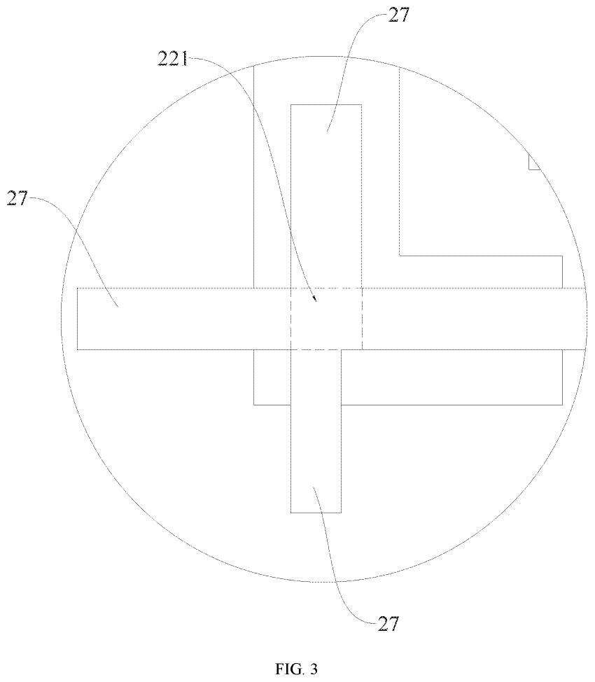

The common electrode wire 21 comprises a metal wire 212 and a productive layer 211 covering the metal wire 212, the productive layer 211 defines therein a conductive hole 221 to expose the metal wire 212, and the second conductive layer 22 is arranged in the conductive hole 221 and in electrical connection with the metal wire 212 and the first conductive layer 13. The conductive hole 221 is shown by broken lines in FIG. 3. Optionally, the productive layer 211 is the productive layer 211 made of a nitrogen silicon compound, the metal wire 212 is a metal wire 212 made of copper which has abundant resources and good electrical conductivity.

As shown in FIGS. 1-3, a surface of the productive layer 211 is provided with a plurality of conductive strips 27. The respective conductive strip 27 is in electrical connection with the second conductive layer 22 and circumferentially arranged along the conductive hole 221. Optionally, the number of the conductive strips 27 is four, and the conductive strips 27 cover a surface of the productive layer 211 and are in electrical connection with the second conductive layer 22.

The first conductive layer 13 may be in electric contact with the second conductive layer 22 disposed in the conductive hole 221. In the circumstance that relative sliding between the first substrate 11 and the second substrate 24 occurs, which causes relative movement between the first conductive layer 13 and the second conductive layer 22, the conductive strips 27 uniformly arranged in four directions can ensure electrical contact between the first conductive layer 13 and the second conductive layer, thereby reinforcing the stability of the electrical connection between the first conductive layer 13 and the second conductive layer 22. Optionally, the conductive strips 27 are also made of indium tin oxide.

The color resist material of the first color resist 141 comprises a red color resist, a blue color resist, and a green color resist. A color resist material of the second color resist 142 comprises a red color resist, a blue color resist, or a green color resist. The red color resist, the blue color resist, and the green color resist are arranged on the first color resist 141 and are spaced apart from one another. The first color resist 141 is configured to adjust the light transmission color to display a desired color. When the second color resist 142 comprises one or more of the red color resist, the blue color resist, and the green color resist, the second color resist 142 may also be configured to adjust the light transmission color. The first color resist 141 adopts a layer arrangement, and the second color resist 142 adopts a column arrangement in order to support the first color resist 141.

In one embodiment, the color resist material of the second color resist 142 comprises one of the red color resist, the blue color resist, and the green color resist, that is, the second color resist 142 is a monochrome color resist comprising only one color resist.

In one embodiment, the second color resist 142 may be a complex color resist comprising any two color resists, that is, the color resist material of the second color resist 142 may comprise the red color resist and the blue color resist, or may comprise the red color resist and the green color resist, or may comprise the blue color resist and the green color resist.

In one embodiment, the second color resist 142 comprises the red color resist, the blue color resist, and the green color resist, that is, the second color resist 142 is a complex color resist formed by three color resists.

In one embodiment, the second color resist 142 may not comprise any of the red color resist, the blue color resist, and the green color resist, but rather comprise a supporting transparent material, such as a resin, which may also achieve the purpose of supporting the first color resist 141.

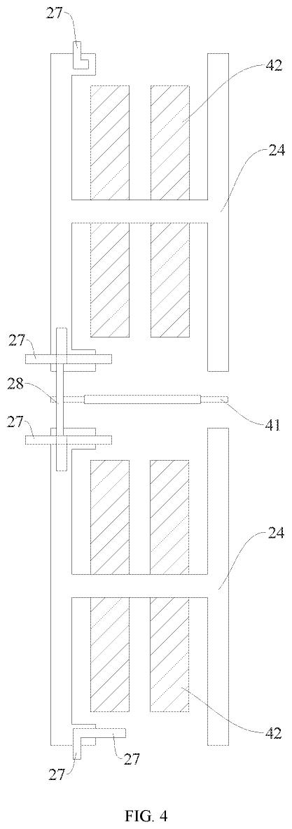

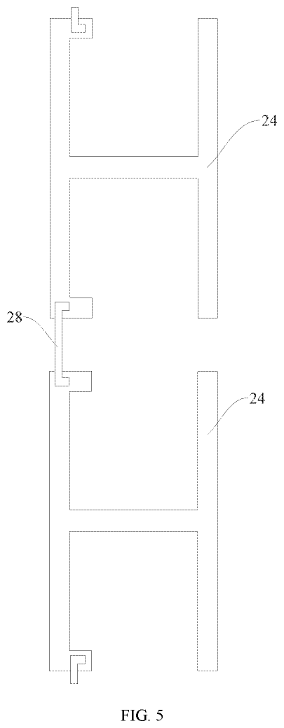

As shown in FIGS. 4-5, a plurality of common electrode wires 21 are spaced apart from one another. The array structure layer 20 further comprises a conductive bar 28 in connection with two adjacent common electrode wires 21, to ensure the stability of the electrical signals transmitted by the respective common electrode wire 21. Optionally, the second conductive layers 22 disposed in the two adjacent conductive holes 221 are electrically connected via the conductive bar 28, so that electrical signals can be stably transmitted outward through the common electrode wires 21. The conductive bar 28 is made of indium tin oxide. Optionally, the respective common electrode wire 21 is arranged in an H-shape, the array structure layer 20 further comprises: pixel conductive layers 42 connected to the respective common electrode wire 21, and a source wire 41 arranged between two adjacent common electrode wires 21, and the source wire 41 is electrically connected to the conductive bar 28. The pixel conductive layer 42 is made of indium tin oxide.

The black matrix layer 12 is arranged between the first color resist 141 and the first substrate 11. An area of the first color resist 141 is smaller than an area of a region enclosed by the black matrix layer 12, such that the black matrix layer 12 completely covers the color filter layer 14. The first conductive layer 13 comprises: a primary conductive layer covering a surface of the color filter layer 14, and a secondary conductive layer in connection with the primary conductive layer and covering the black matrix layer 12. The black matrix layer 12 is configured to absorbing an external light and functions in shading the light. In the fabrication of the color film structure layer 10, the black matrix layer 12 is firstly fabricated on the first substrate 11, the color filter layer 14 is then fabricated on the black matrix layer 12, and after that, the first conductive layer 13 is fabricated on the color filter layer 14.

The display panel 100 further comprises an annular seal 23 configured for sealing the color film structure layer 10 and the array structure layer 20. By the annular seal 23, the color film structure layer 10 and the array structure layer 20 can be hermetically coupled together, in this way, the liquid crystal layer 70 may be sealed between the color film structure layer 10 and the array structure layer 20.

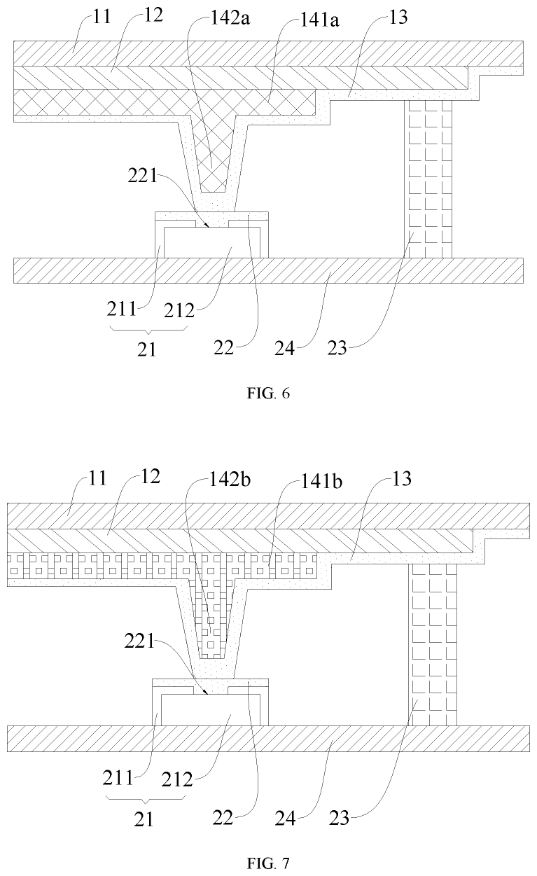

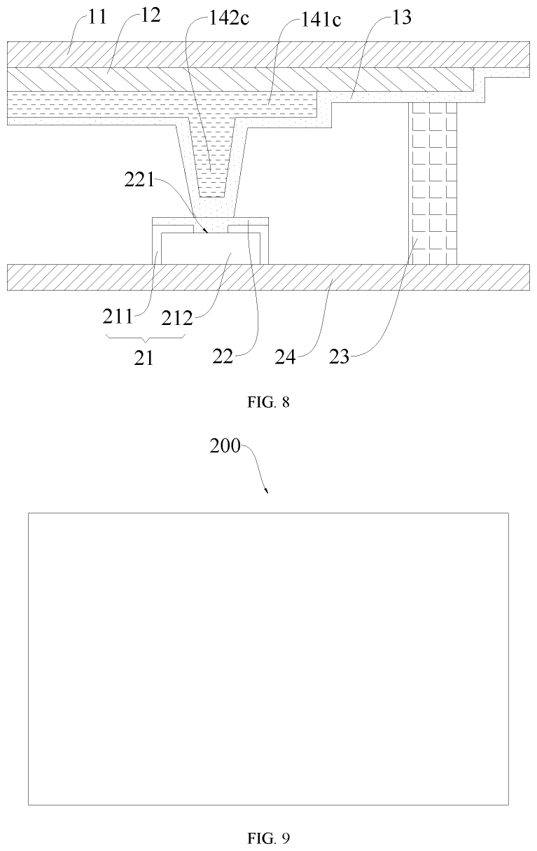

As shown in FIGS. 6-8, in one embodiment, the display panel comprises: a first substrate 11, a color filter layer 14, and an array structure layer 20. The first substrate 11 is covered by the color filter layer 14. The color filter layer 14 comprises a first color resist 141 and a second color resist 142 overlying on the first color resist 141. The first color resist 141 comprises a red color resist 141a, a green color resist 141b, and a blue color resist 141c. The second color resist 142 comprises a red boss 141a integrally connected with the red color resist 141a, a green boss 142b integrally connected with the green color resist 141b, and a blue boss 143c integrally connected with the blue color resist 141c. The color filter layer 14 further comprises a black matrix layer 12 and a first conductive layer 13. The black matrix layer 12 is arranged between the color filter layer 14 and the first substrate 11. The color filter layer 14 is covered by the first conductive layer 13. The array structure layer 20 comprises: a second substrate 24, a common electrode wire 21, and a second conductive layer 22. The second substrate 24 is arranged opposite the first substrate 11. The common electrode wire 21 is arranged at the second substrate 24. The second conductive layer 22 is in electrical connection with the common electrode wire 21. The first conductive layer 13 is pressed via the second color resists 142 into electrical connection with the second conductive layer 22.

Optionally, the first color resist 141 and the second color resist 142 are integrally formed, that is, the green color resist 141b of the first color resist 141 is integrally formed to form the green boss 142b, and the red color resist 141a of the first color resist 141 is integrally formed to form the red boss 141a, and the blue color resist 141c of the first color resist 141 is integrally formed to form the blue boss 143c, thus facilitating mass production of the display panel.

The above description is only optional embodiments of the present application, and is not intended to limit the present application. Any modifications, equivalent substitutions, and improvements made within the spirit and principles of the present application are included in the protection scope of the present application.

What is claimed is:

1. A display panel, comprising a color film structure layer and an array structure layer;
the color film structure layer comprising:
a first substrate;
a color filter layer, covering the first substrate and comprising a first color resist and second color resists overlying on the first color resist;
a black matrix layer, arranged between the color filter layer and the first substrate; and
a first conductive layer, covering the color filter layer; and
the array structure layer comprising:
a second substrate, arranged opposite the first substrate;
a common electrode wire, arranged at the second substrate; and
a second conductive layer, in electrical connection with the common electrode wire;
wherein the first conductive layer is pressed via the second color resists into in electrical connection with the second conductive layer.

2. The display panel of claim 1, wherein the common electrode wire is provided with a productive layer; the productive layer defines therein with a conductive hole to expose the common electrode wire; the second conductive layer passes through the conductive hole and is in electrical connection with the common electrode wire and the first conductive layer.

3. The display panel of claim 2, wherein a surface of the productive layer is provided with a plurality of conductive strips; the respective conductive strip is in electrical connection with the second conductive layer and extends in a radial direction of the conductive hole, with all the conductive strips in a radial arrangement.

4. The display panel of claim 3, wherein the number of the conductive strips is four, and the four conductive strips are uniformly arranged and spaced from one another with the same angle.

5. The display panel of claim 1, wherein the first color resist comprises a red color resist, a blue color resist, and a green color resist.

6. The display panel of claim 1, wherein the respective second color resist is a monochrome color resist comprising a red color resist, a blue color resist, or a green color resist.

7. The display panel of claim 1, wherein the respective second color resist is a complex color resist comprising any two of a read color resist, a blue color resist, and a green color resist.

8. The display panel of claim 1, wherein the respective second color resist is a complex color resist comprising a read color resist, a blue color resist, and a green color resist.

9. The display panel of claim 1, wherein the respective second color resist is a transparent color resist.

10. The display panel of claim 1, wherein the first substrate is a glass substrate, and a thickness of the first substrate ranges from 0.52 to 0.58 mm.

11. The display panel of claim 1, wherein the second substrate is a glass substrate, and a thickness of the second substrate ranges from 0.52 to 0.58 mm.

12. The display panel of claim 1, wherein a plurality of common electrode wires are spaced from one another; and the array structure layer further comprises a conductive bar in connection with two adjacent common electrode wires.

13. The display panel of claim 1, wherein the display panel further comprises a liquid crystal layer; and the liquid crystal layer is arranged between the color film structure layer and the array structure layer.

14. The display panel of claim 14, wherein the display panel further comprises an annular seal configured to seal the color film structure layer and the array structure layer.

15. A display panel, comprising:
a first substrate;
a color filter layer, covering the first substrate and comprising: a first color resist and second color resists overlying on the first color resist; the first color resist comprising a red color resist, a green color resist, and a blue color resist; the respective second color resists comprising a red boss integrally connected with the red color resist, a green boss integrally connected with the green color resist, and a blue boss integrally connected with the blue color resist;
a black matrix layer, arranged between the color filter layer and the first substrate;
a first conductive layer, covering the color filter layer; and
an array structure layer, comprising:
a second substrate, arranged opposite the first substrate;
a common electrode wire, arranged at the second substrate; and
a second conductive layer, in electrical connection with the common electrode wire;
wherein the first conductive layer is pressed via the second color resists into in electrical connection with the second conductive layer.

16. A display, comprising a display panel, and the display panel comprising:
a first substrate;
a color filter layer, covering the first substrate and comprising a first color resist and second color resists overlying on the first color resist;
a black matrix layer, arranged between the color filter layer and the first substrate;
a first conductive layer, covering the color filter layer; and
an array structure layer, comprising:
a second substrate, arranged opposite the first substrate;
a common electrode wire, arranged at the second substrate; and
a second conductive layer, in electrical connection with the common electrode wire;
wherein the first conductive layer is pressed via the second color resists into in electrical connection with the second conductive layer.

17. The display panel of claim 16, wherein the first color resist comprises a red color resist, a blue color resist, and a green color resist.

18. The display panel of claim 16, wherein the respective second color resist is a complex color resist comprising any two of a read color resist, a blue color resist, and a green color resist.

19. The display panel of claim 16, wherein the respective second color resist is a complex color resist comprising a read color resist, a blue color resist, and a green color resist.

20. The display panel of claim 16, wherein the respective second color resist is a transparent color resist.
